(19) United States
(12) Patent Application Publication
(10) Pub. No.: US 2026/0322910 A1
(43) Pub. Date: Oct. 15, 2026

(54) PORTABLE HOLDER

(71) Applicant: Dongguan Dongdingyun Technology Co., Ltd., Dongguan (CN)

(72) Inventor: XIUXI LIU, Dongguan (CN)

(21) Appl. No.: 19/207,500

(22) Filed: May 14, 2025

(30) Foreign Application Priority Data
Apr. 15, 2025 (CN) 202520709465.8

(51) Int. Cl. H04M 1/04; F16M 11/04; F16M 11/10; F16M 11/24

(52) U.S. Cl. CPC H04M 1/04; F16M 11/041; F16M 11/10; F16M 11/242

(57) ABSTRACT

Disclosed is a portable holder, including a mounting plate and a support plate, the mounting plate is rotatably connected to the support plate, and a handheld assembly is arranged on the mounting plate; the handheld assembly includes a cover plate and a connecting member, one end of the connecting member is provided with a first connecting portion connected to the cover plate, and the other end thereof is provided with a second connecting portion connected to the mounting plate; first and second protrusion portions of the connecting member fit snugly into the first recess on the cover plate and the second recess on the mounting plate, respectively, and first and second pressing plates adopt compressive engagement, which increases contact areas, and the stability of connection, among the connecting member, the cover plate, and the mounting plate.

### CROSS-REFERENCE TO RELATED APPLICATIONS

This application claims priority to Chinese Patent Application No. 202520709465.8, filed on Apr. 15, 2025, which is hereby incorporated by reference in its entirety.

### TECHNICAL FIELD

The present disclosure belongs to the field of holders for electronic products, and particularly relates to a portable holder.

### BACKGROUND

With the rapid popularization of electronic products such as mobile phones and tablets, these products have become indispensable communication tools in people’s daily lives. However, the electronic products usually feature smooth and flat handheld surfaces, which make them prone to slipping from a user's hand during use, and even increase a risk of being snatched.

In addition, when the user holds or carries the electronic product for a prolonged period of time, his/her hands may become fatigued and sore. Although electronic product holders in the prior art can alleviate hand soreness, most existing holders are usually smaller, and lack sufficient support and durability. In contrast, those with excellent support performance tend to be large and bulky, making them inconvenient for portable storage.

### SUMMARY

### (1) Technical problem to be solved

The present disclosure provides a portable holder, aiming to solve the problems that an electronic product suffers from poor handheld stability, and the existing stand devices in the prior art cannot balance storage convenience and support stability.

### (2) Technical solution

The present disclosure provides a portable holder, including a mounting plate and a support plate for supporting the mounting plate, where the mounting plate is rotatably connected to the support plate, a handheld assembly is arranged on the mounting plate; the handheld assembly includes a cover plate and a connecting member, one end of the connecting member is provided with a first connecting portion connected to the cover plate, and the other end thereof is provided with a second connecting portion connected to the mounting plate;

when the handheld assembly is in an open state, the mounting plate and the cover plate are separated from each other, and the connecting member extends transversely between the mounting plate and the cover plate;

when the handheld assembly is in a stowed state, the connecting member is vertically sandwiched between the mounting plate and the cover plate, such that the three members are tightly pressed together for convenient storage; and

a first protrusion portion is formed on one end face of the first connecting portion, a first recess is formed on the cover plate, and the first protrusion portion fits snugly into the first recess; and a first recessed portion corresponding to the first protrusion portion is formed on the other end face of the first connecting portion, a first pressing plate is arranged in the first recessed portion, and the first pressing plate and the cover plate are configured to clamp and secure the first connecting portion.

Further, the first pressing plate is secured to the cover plate via a riveted connection or screws.

Further, a protruding ring is arranged in the first recessed portion, and a recessed ring in fitted connection with the protruding ring is arranged on the first pressing plate.

Further, a second protrusion portion is formed on one end face of the second connecting portion, a second recess in fitted connection with the second protrusion portion is formed on the mounting plate, a second recessed portion corresponding to the second protrusion portion is formed on the other end face of the second connecting portion, a second pressing plate is arranged in the second recessed portion, and the second pressing plate and the mounting plate are configured to clamp and secure the second connecting portion.

Further, the second pressing plate is secured to the mounting plate via a riveted connection or screws.

Further, the connecting member is provided with a crease groove.

Further, the cover plate is provided with a receiving slot that corresponds to the connecting member, and a depth of the receiving slot is dimensioned to match a thickness of the connecting member.

Further, the mounting plate is provided with a placement recess that corresponds to the cover plate, and a depth of the placement recess is dimensioned to match a thickness of the cover plate.

Further, the mounting plate is provided with a first magnetic member, the cover plate is provided with a second magnetic member magnetically attracted to the first magnetic element, the first magnetic member is a magnet, and the second magnetic member is a magnet or a magnetically conductive material.

Further, the support plate includes a main plate, a left plate, and a right plate, one end of the support plate is rotatably connected to the mounting plate, and the left plate and the right plate are rotatably connected to two sides of the main plate, such that the main plate, the left plate, and the right plate can be separated from each other two by two to form a triangular standing configuration for supporting the mounting plate.

Compared with the prior art, the present disclosure has the following beneficial effects:

By arranging a handheld assembly capable of freely switching between a stowed state and an open state, the present disclosure effectively solves the problems of unstable handheld use and low safety in electronic products. In addition, the first protrusion portion and the second protrusion portion of the connecting member fit snugly into the first recess on the cover plate and the second recess on the mounting plate, respectively, and the first pressing plate and the second pressing plate adopt compressive engagement, which increases the contact areas between the connecting member and the cover plate, and between the connecting member and the mounting plate, and enhances the stability of connection between the connecting member and the cover plate and the mounting plate, thereby resulting in a more stable and secure connection.

### BRIEF DESCRIPTION OF THE DRAWINGS

FIG. 1 is a schematic diagram of a handheld assembly according to the present disclosure in an open state.

FIG. 2 is a schematic diagram of a handheld assembly according to the present disclosure in a use state.

FIG. 3 is a schematic diagram of a handheld assembly according to the present disclosure in a stowed state.

FIG. 4 is a first exploded view of a handheld assembly according to the present disclosure.

FIG. 5 is a sectional view of a sectional line P in FIG. 3 according to the present disclosure.

FIG. 6 is a second exploded view of a handheld assembly according to the present disclosure, and FIGS. 6A and 6B are schematic diagrams of the handheld assembly from different angles of view.

FIG. 7 is a schematic structural diagram of a connecting member according to the present disclosure.

FIG. 8 is a schematic structural diagram of a handheld assembly according to the present disclosure, and FIGS. 8A and 8B are schematic diagrams according to two different embodiments.

FIG. 9 is a schematic structural diagram of a cover plate according to the present disclosure.

FIG. 10 is a schematic diagram showing magnetic attraction among an electronic product, a mounting plate, and a cover plate according to the present disclosure.

FIG. 11 is a schematic structural diagram of a placement recess according to the present disclosure.

FIG. 12 is a first schematic diagram of a portable holder according to the present disclosure in a use state.

FIG. 13 is a second schematic diagram of a portable holder according to the present disclosure in a use state.

FIG. 14 is a third schematic diagram of a portable holder according to the present disclosure in a use state.

FIG. 15 is a schematic structural diagram of a latching mechanism according to the present disclosure.

Reference numerals in the accompanying drawings: 1. mounting plate; 11. second recess; 12. placement recess; 13. first magnetic member; 14. stowing area; 15. limiting portion; 16. through hole; 17. push-out portion; 2. support plate; 21. main plate, 22. left plate; 23. right plate; 24. anti-slip sleeve; 3. handheld assembly; 31. cover plate; 311. first recess; 312. screw; 313. receiving slot; 314. second magnetic member; 3141. positioning hole; 315. soft housing; 3151. support hole; 32. connecting member; 321. first connecting portion; 322. second connecting portion; 323. first protrusion portion; 324. first recessed portion; 325. protruding ring; 326. second protrusion portion; 327. second recessed portion; 328. crease groove; 329. gripping portion; 33. first pressing plate; 331. recessed ring; 34. second pressing plate; 4. electronic product; 5. latching mechanism; 51. latch hook; and 52. latch slot.

### DETAILED DESCRIPTIONS OF THE EMBODIMENTS

The technical solutions of embodiments of the present disclosure will be described below clearly and comprehensively in conjunction with accompanying drawings of the embodiments of the present disclosure.

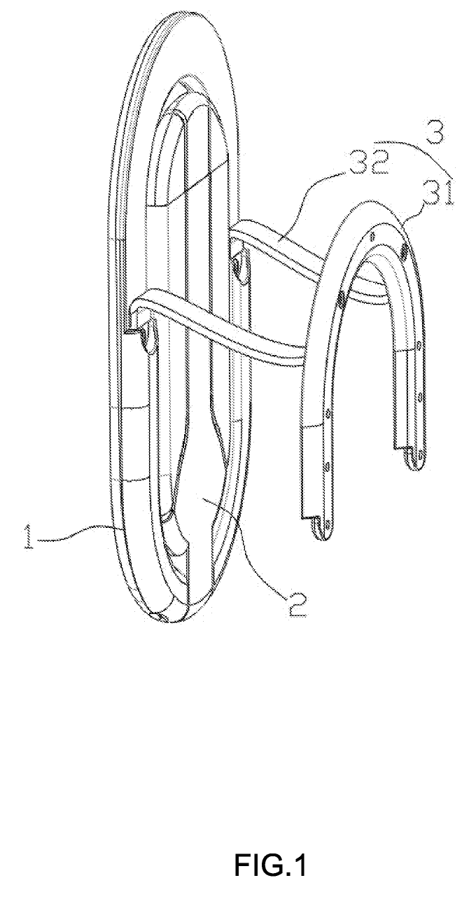

As shown in FIGS. 1-7, the present disclosure provides a portable holder, including a mounting plate 1 fixed to a back of an electronic product 4 (such as a mobile phone or a tablet), where a handheld assembly 3 is arranged on the side of the mounting plate 1 facing away from the electronic product 4, the handheld assembly 3 includes a cover plate 31 and a connecting member 32, one end of the connecting member 32 is provided with a first connecting portion 321 connected to the cover plate 31, and the other end thereof is provided with a second connecting portion 322 connected to the mounting plate 1; and the connecting member 32 is made of a flexible material, such as a soft rubber material or a silicone material;

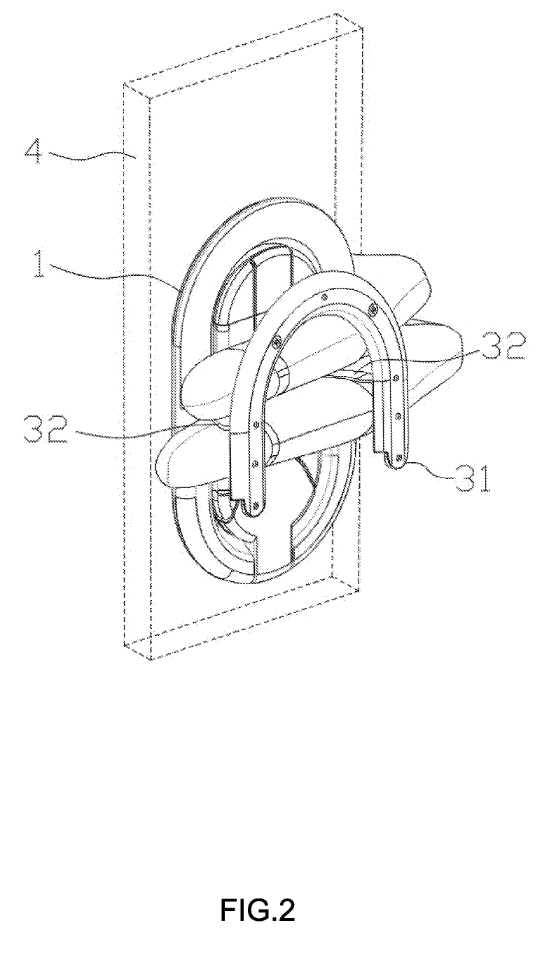

during use, the handheld assembly 3 may be freely switched between an open state and a stowed state according to a user’s usage needs; specifically, when the handheld assembly 3 is in the open state (as shown in FIG. 2), the mounting plate 1 and the cover plate 31 are separated from each other, and the connecting member 32 extends transversely between the mounting plate 1 and the cover plate 31 to form an “H”-shaped structure as a whole, in this state, the user can insert two or more adjacent fingers between the mounting plate 1 and the cover plate 31 to grip the connecting member 32, such that inner sides of the fingers are in contact with the back of the electronic product 4 and the mounting plate 1, and outer sides of the fingers are in contact with the cover plate 31. By arranging the mounting plate 1 and the cover plate 31 on the inner and outer sides of the fingers to securely grip and hold the finger in place, and clamping and fixing the connecting member 32 by the fingers, the electronic product 4 can be effectively fixed by hand, thereby effectively solving the problem of accidentally slipping due to the smooth back of the electronic product 4 such as the mobile phone, and even effectively reducing the probability of thief forcibly snatching the mobile phone from the user, further enhancing the safety of the electronic product 4; and

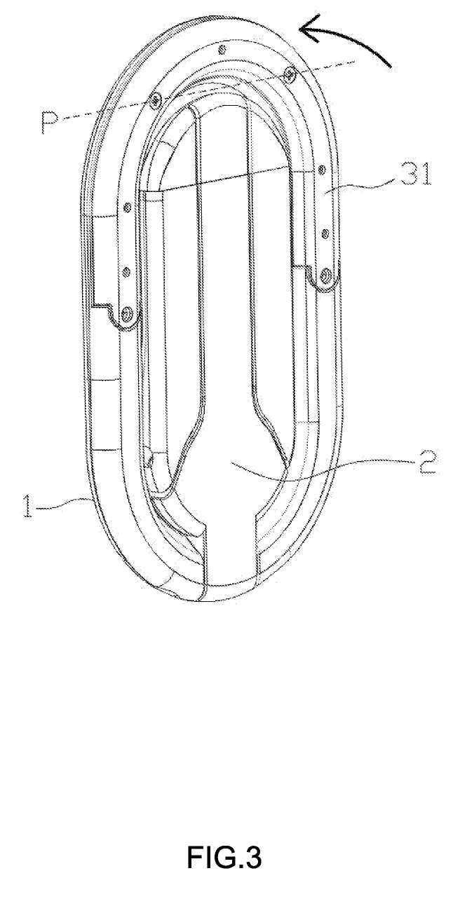

in addition, as shown in FIGS. 2-3, when the cover plate 31 is moved toward the mounting plate 1 in the open state, the connecting member 32 gradually changes from a horizontal extension to a vertical extension; and when the connecting member 32 is vertically sandwiched between the mounting plate 1 and the cover plate 31, and the three members are tightly pressed together, the handheld assembly 3 is in the stowed state. In this stowed state, an overall volume of the portable holder is smaller, making it more convenient for carrying and storage.

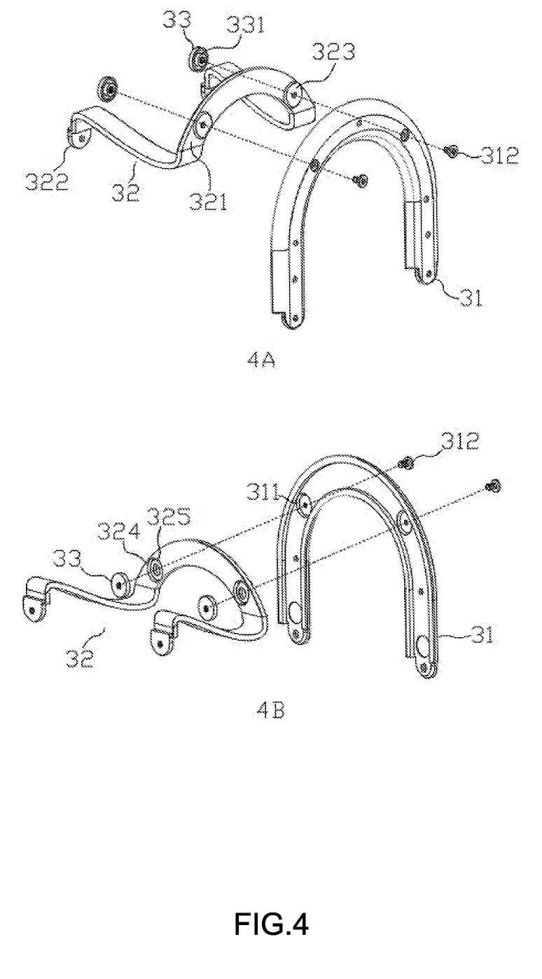

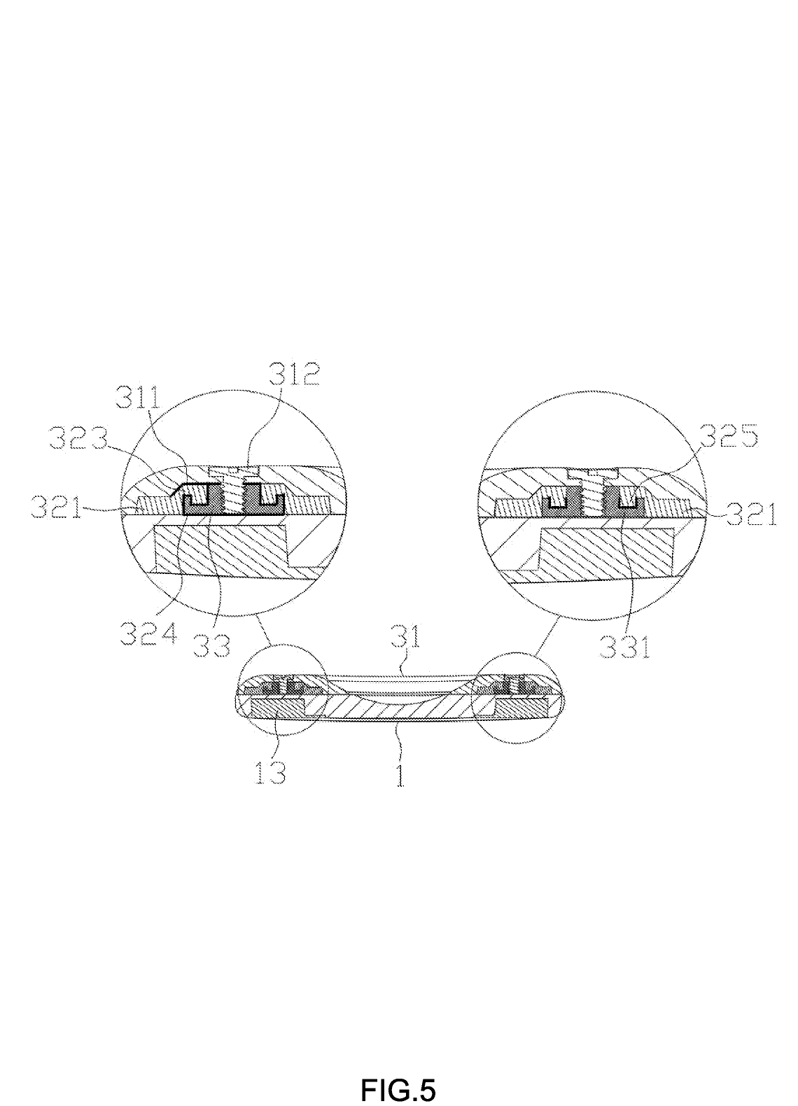

Specifically, as shown in FIGS. 4-5, where FIG. 5 is a sectional view of a sectional line P in FIG. 3, a first protrusion portion 323 is formed on the first connecting portion 321 of the connecting member 32 and on an end face near the cover plate 31, a first recess 311 corresponding to the first protrusion portion 323 is formed on the cover plate 31, and the first protrusion portion 323 fits snugly into the first recess 311; and through the fitted connection design of the first protrusion portion and the first recess 311, the first connecting portion 321 can be securely fixed on the cover plate 31, preventing misalignment between the cover plate 31 and the first connecting portion 321 during use; and

in order to further enhance the stability of connection between the first connecting portion 321 and the cover plate 31, a first recessed portion 324 corresponding to a position of the first protrusion portion 323 is formed on the end face of the first connecting portion 321 facing away from the cover plate 31, and a first pressing plate 33 is arranged in the first recessed portion 324; where the first pressing plate 33 is fixedly connected to the cover plate 31, and are configured to clamp and secure the first connecting portion 321 together; by arranging the first pressing plate 33, a fixing area between the first connecting portion 321 and the cover plate 31 is effectively increased, thereby enhancing the firmness of connection between them.

In one embodiment, the first pressing plate 33 is secured to the cover plate 31 via a riveted connection, thereby increasing the firmness of connection between them with the connecting member 32;

in another embodiment, compared with an undetachable design of the riveted connection, the first pressing plate 33 may be fixed to the cover plate 31 by a detachable connection using screws 312; specifically, the screws 312 pass through the cover plate 31 and the connecting member 32 in sequence, and is then in threaded connection with the first pressing plate 33; alternatively, the screws 312 may pass through the first pressing plate 33 and the connecting member 32 in sequence, and be in threaded connection with the cover plate 31. The detachable design effectively improves the mounting and manufacturing efficiency of the holder, and facilitates disassembly and maintenance of the holder;

further, as shown in FIG. 5, in order to enhance clamping and fastening force exerted by the first pressing plate 33 and the cover plate 31 on the first connecting portion 321, and to prevent the first pressing plate 33 from sliding or deviating in the first recessed portion 324, a protruding ring 325 is arranged inside the first recessed portion 324, and a recessed ring 331 that fits snugly into the protruding ring 325 is formed on the first pressing plate 33; and relatively, positions of the protruding ring 325 and the recessed ring 331 between the first pressing plate 33 and the first recessed portion 324 may be interchanged, which does not affect the actual use effect; and

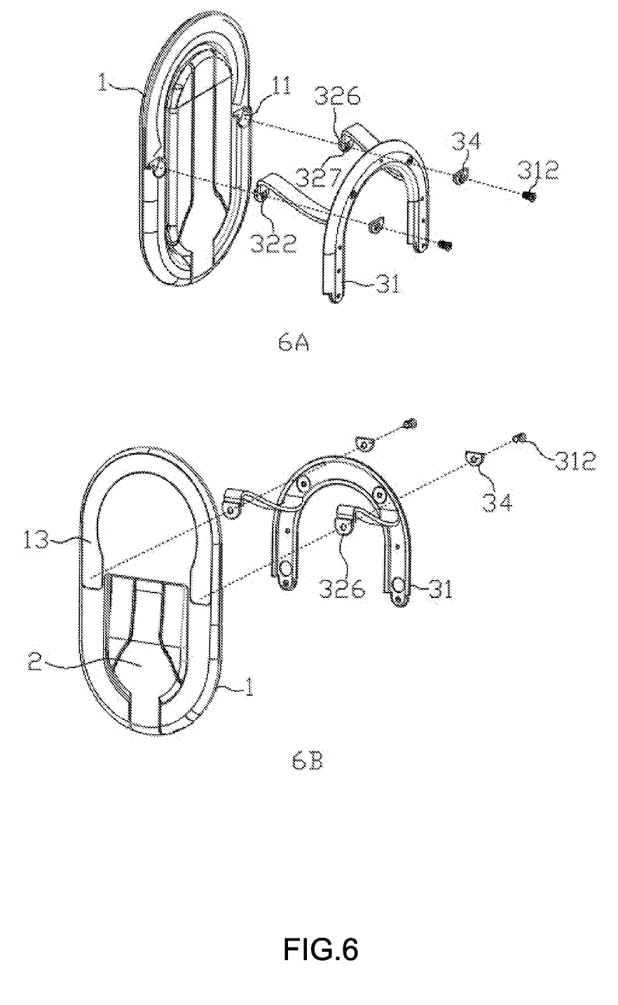

specifically, as shown in FIG. 6, a second protrusion portion 326 is formed on the end face of the second connecting portion 322 of the connecting member 32 and near the mounting plate 1, a second recess 11 that fits snugly into the second protrusion portion 326 is formed on the mounting plate 1; and a second recessed portion 327 corresponding to a position of the second protrusion portion 326 is formed on the end face of the second connecting portion 322 facing away from the mounting plate 1, and a second pressing plate 34 is arranged in the second recessed portion 327; where the second pressing plate 34 is fixedly connected to the mounting plate 1, and are configured to clamp and secure the second connecting portion 322 together; and a function of the second pressing plate is the same as that of the first pressing plate 33, that is, increasing a fixing area between the second connecting portion 322 and the mounting plate 1, so as to achieve the purpose of enhancing the firmness of connection between them.

In one embodiment, the second pressing plate 34 is secured to the mounting plate 1 via a riveted connection, thereby increasing the firmness of connection of them to the connecting member 32;

In another embodiment, the second pressing plate 34 may be fixed to the mounting plate 1 by a detachable connection using screws 312, that is, the screws 312 pass through the second pressing plate 34 and the connecting member 32 in sequence, and is then in threaded connection with the mounting plate 1; alternatively, the screws 312 may pass through the mounting plate 1 and the connecting member 32 in sequence, and be then in threaded connection with the second pressing plate 34, thereby improving the convenience of mounting and removal of the holder.

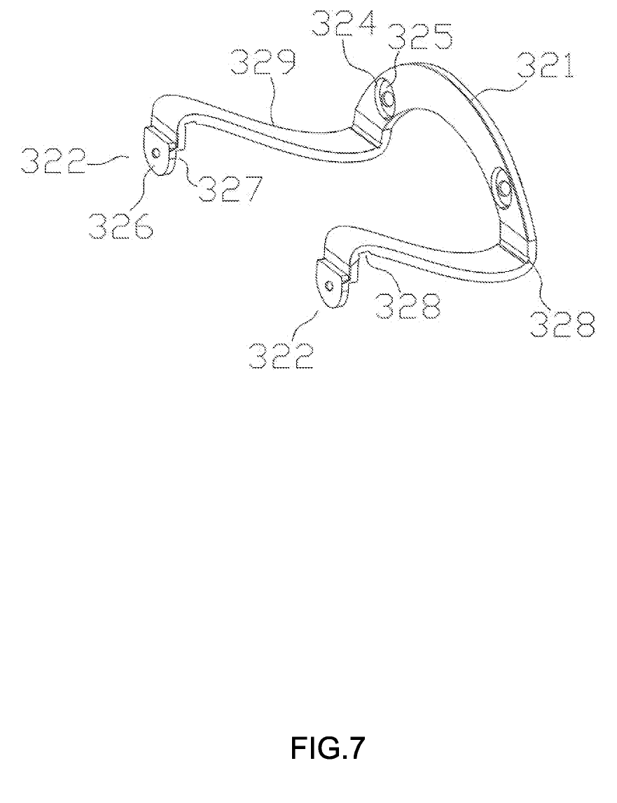

Specifically, as shown in FIG. 7, in order to improve the convenience and flexibility of switching between the open state and the stowed state of the handheld assembly 3, crease grooves 328 are formed on the connecting member 32 near the first connecting portion 321 and near the second connecting portion 322, facilitating bending of the connecting member 32.

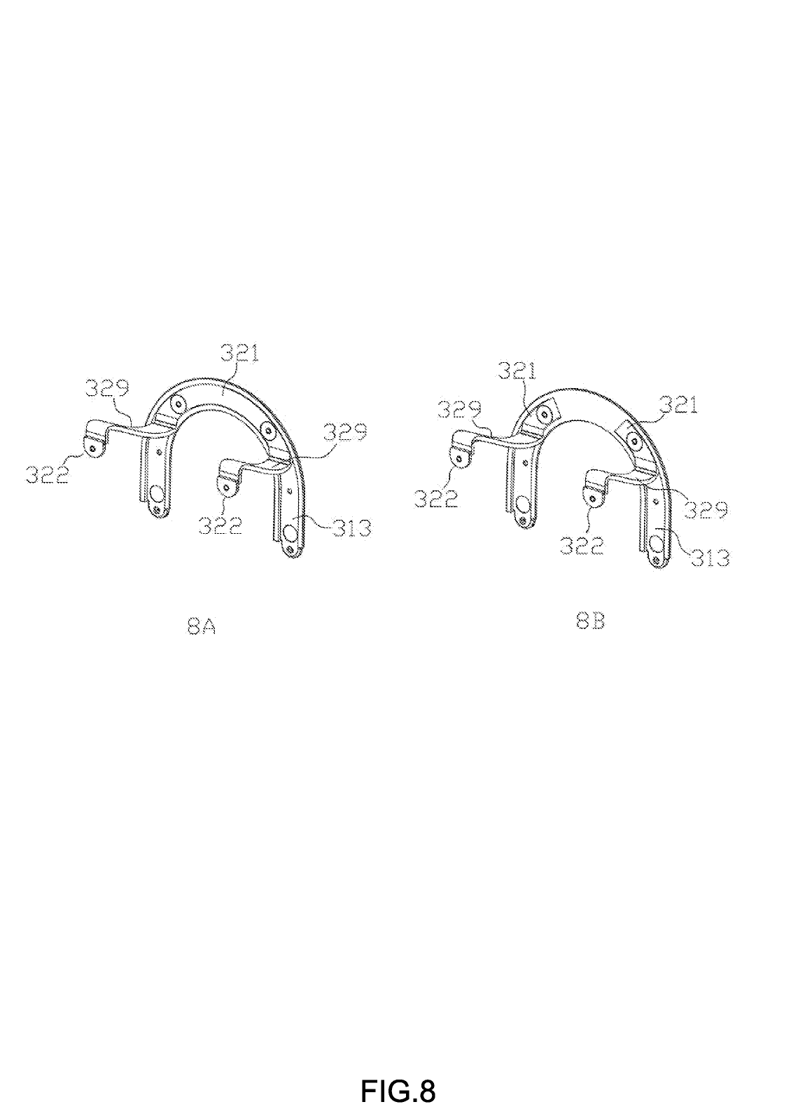

Specifically, as shown in FIGS. 7 and 8A, in one embodiment, the connecting member 32 is integrally formed into a "U"-shaped structure, and includes the first connecting portion 321, the second connecting portion 322, and a gripping portion 329 disposed between the first connecting portion and the second connecting portion in sequence. When in use, the user grips the gripping portion 329 with his/her fingers. In this embodiment, two gripping portions 329 are provided, one end of each of the gripping portions is connected to the first connecting portion 321, and the other end thereof is connected to the second connecting portion 322. By arranging two symmetrically arranged gripping portions 329, the stability of connection between the cover plate 31 and the mounting plate 1 is effectively enhanced, and the fixing effect of the two gripping portions 329 on the user’s hand is further enhanced.

In another embodiment, as shown in FIG. 8B, two connecting members 32 are symmetrically arranged between the mounting plate 1 and the cover plate 31. Each connecting member 32 is elongated and includes the first connecting portion 321, second connecting portion 322, and a gripping portion 329 disposed between the first connecting portion and the second connecting portion. The first connecting portions 321 at one end of the two connecting members 32 are respectively connected to the cover plate 31, and the second connecting portions 322 at the other end thereof are respectively connected to the mounting plate 1. By arranging the two connecting members 32, the stability of connection between the cover plate 31 and the mounting plate 1 can also be effectively enhanced, and the fixing effect of the two connecting members 32 on the user’s hand is also enhanced.

Specifically, as shown in FIG. 8, the cover plate 31 is provided with a receiving slot 313 that is recessed inward and corresponds to the connecting member 32, and a depth of the receiving slot 313 is dimensioned to match a thickness of the connecting member 32. In the stowed state, the connecting member 32 fits snugly into the receiving slot 313, such that end faces of the cover plate 31 and the connecting member 32 on a same side can be in a same plane in the stowed state, thereby making the end face of the cover plate 31 facing the mounting plate 1 flatter and more integrated, facilitating storage and improving aesthetics.

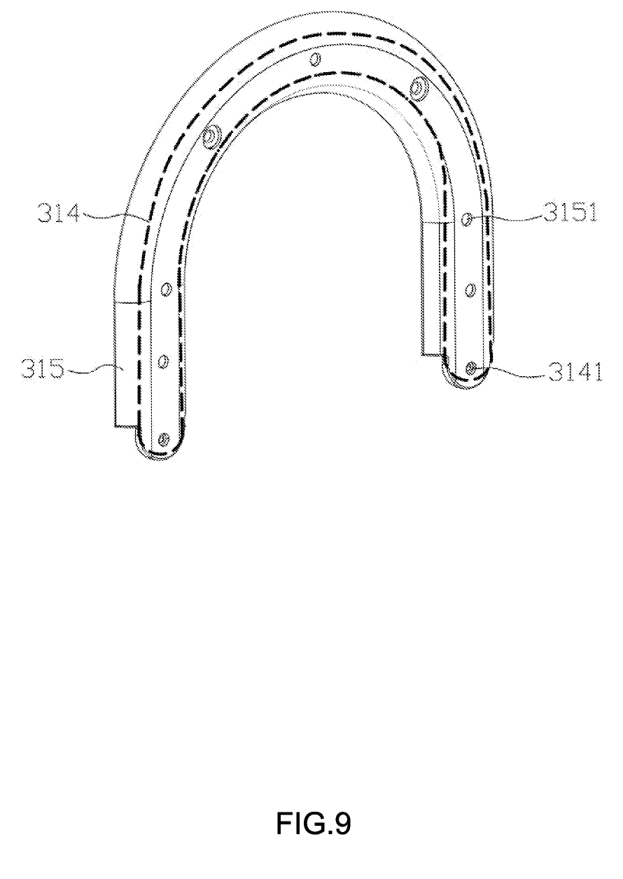

Specifically, as shown in FIG. 9, the cover plate 31 also has an overall U-shaped structure, the cover plate 31 is formed by secondary injection molding of a second magnetic member 314 and a soft housing 315, that is, the second magnetic member 314 is placed in an injection molding cavity, and the soft housing 315 in a molten state is injected, such that the soft housing 315 wraps and covers an outer periphery of the second magnetic member 314. The soft housing 315 is made of a soft and flexible material, which not only effectively increases friction with the hand but also improves comfort of contact with the user's hand, thereby improving the user experience; and

further, the second magnetic member 314 is provided with a plurality of positioning holes 3141 for injection molding fixation, and the soft housing 315 is provided with a plurality of support holes 3151 for penetrating the soft housing 315 and providing injection molding support to secure the second magnetic member 314.

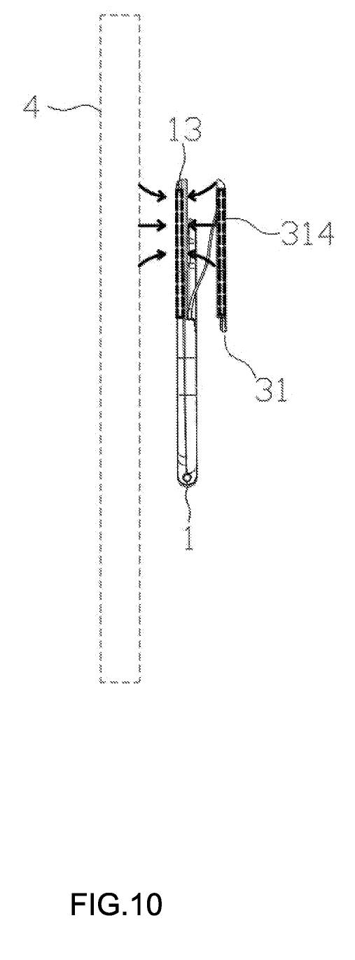

Specifically, as shown in FIG. 10, a first magnetic member 13 is arranged on the mounting plate 1 and on the side near the electronic product 4, and the second magnetic member 314 on the cover plate 31 is configured to be attracted to the first magnetic member 13; and preferably, the second magnetic member 314 may be a magnet or a magnetically conductive material, and the first magnetic member 13 is preferably a magnet; and

when in use, the mounting plate 1 is effectively attracted to the back of the electronic product 4 via the first magnetic member 13, and the end of the first magnetic member 13 away from the mounting plate 1 exerts attractive force on the second magnetic member 314, such that when the handheld assembly 3 in the stowed state, the cover plate 31 can be effectively attracted and fixed on the mounting plate 1 to maintain the stowed state, thereby facilitating the carrying and storage of the holder.

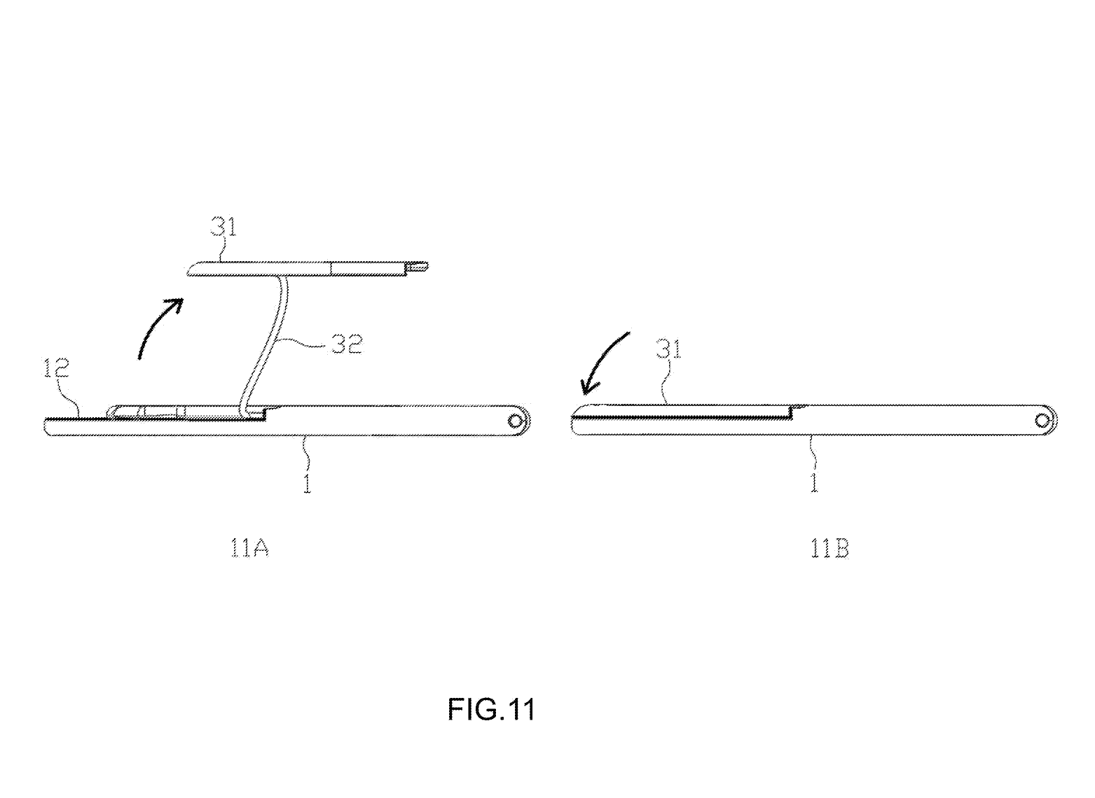

Specifically, as shown in FIG. 11, the mounting plate 1 is provided with a placement recess 12 corresponding to position and structure of the cover plate 31, a depth of the placement recess 12 is dimensioned to match a thickness of the cover plate 31, and the first magnetic member 13 corresponds to the placement recess 12 in front and back positions and is configured in a matching shape, such that the end face of the mounting plate 1 facing away from the electronic product 4 and the end face of the cover plate 31 facing away from the mounting plate 1 can be in a same plane in the stowed state, making the storage of the mounting plate 1 and the cover plate 31 more integrated and convenient for storage, and improving the aesthetics.

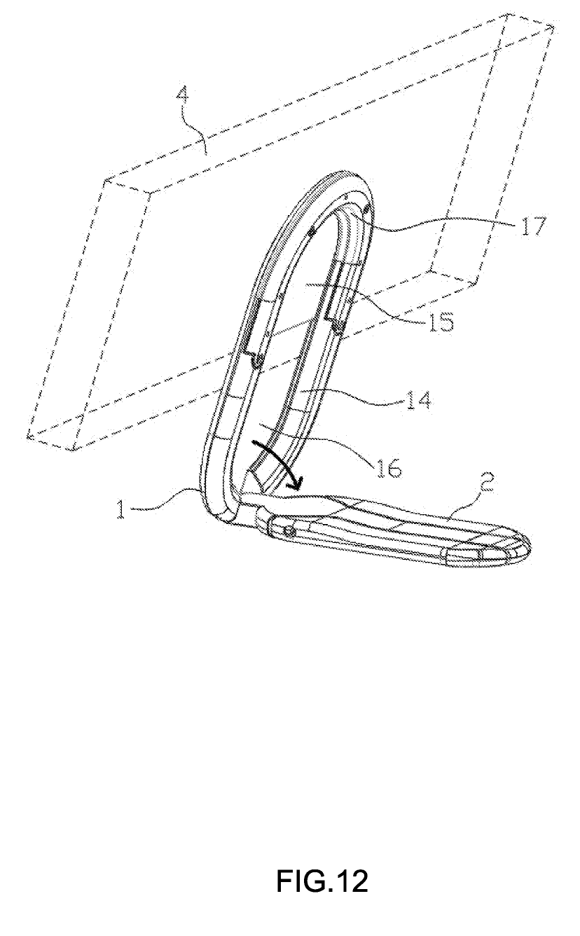

Specifically, as shown in FIG. 12, the holder further includes a support plate 2 for supporting the mounting plate 1 and the electronic product 4, and the mounting plate 1 is rotatably connected to the support plate 2. An inwardly recessed stowing area 14 is arranged on the mounting plate 1 and on a same side as the handheld assembly 3, a shape of the stowing area 14 is adapted to a shape of the support plate 2, such that the support plate 2 can be moved into the stowing area 14 by rotation for stowing, and can also be separated from the stowing area 14 by rotation to abut against a tabletop or a ground, thereby forming a support state for the mounting plate 1. By arranging the stowing area 14, an overall thickness of the holder is reduced when the support plate 2 is stowed, thereby improving the convenience of carrying and storage of the holder.

In order to facilitate the rotation of the support plate 2 out of the stowing area 14, a push-out portion 17 is arranged at an edge of the stowing area 14, and the push-out portion 17 is formed as a recessed arc surface or a section structure. When the support plate 2 is stored in the stowing area 14, the user can insert a finger into the push-out portion 17 and press against a peripheral wall at one end of the support plate 2 to pry out the support plate 2 from the stowing area 14;

in addition, to prevent the support plate 2 from continuing to rotate after entering the stowing area 14 and causing damage to the back of the electronic product 4, a limiting portion 15 is arranged on an inner side of the stowing area 14. When the support plate 2 is stored in the stowing area 14, the limiting portion 15 is located between the support plate 2 and the electronic product 4, thereby effectively improving the usability and safety of the holder; and

further, since the fixing plate 1 and the electronic product 4 are connected by magnetic attraction, in actual use, the user may rotate the electronic product 4 to switch between a landscape mode and a portrait mode of the mobile phone without changing a position of the holder. A through hole 16 is formed in the stowing area 14 and on a same side as the limiting portion 15. When the mobile phone is used in the landscape mode, as shown in FIG. 12, a length direction of the holder may be staggered or perpendicular to a length direction of the mobile phone, in this case, the through hole 16 is located outside an overlapping region with the mobile phone, such that the user can push the support plate 2 away from the mobile phone by passing his/her fingers through the though hole 16 from the end face of the mounting plate 1 near the mobile phone, which not only provides an alternative method for pushing out the support plate 2, but also effectively improves the practicality of the holder.

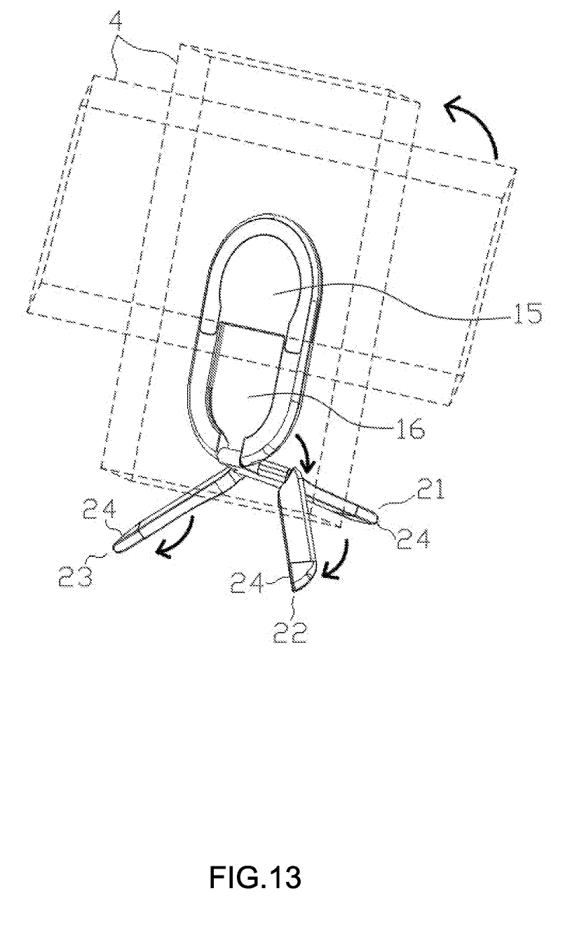

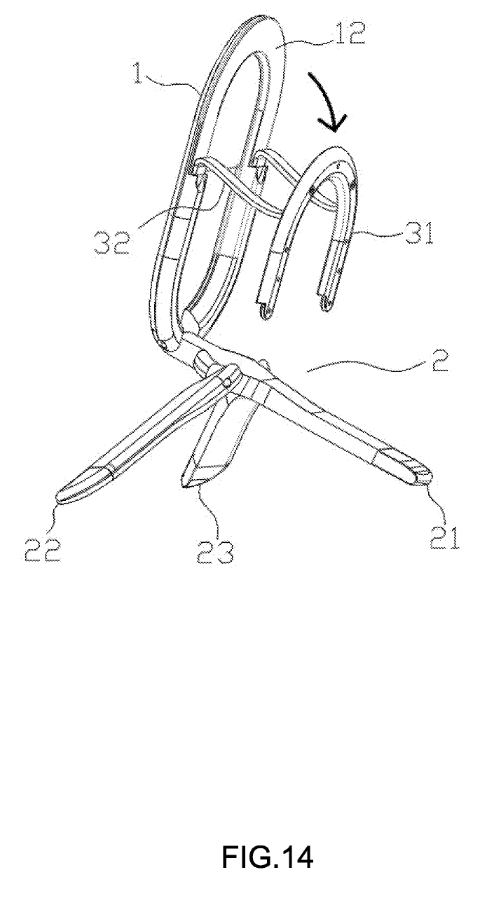

Specifically, in order to better support and secure the mounting plate 1, as shown in FIGS. 13-14, the support plate 2 includes a main plate 21, a left plate 22, and a right plate 23, one end of the support plate 2 is rotatably connected to the mounting plate 1, and the left plate 22 and the right plate 23 are rotatably connected to two sides of the main plate 21, such that the main plate 21, the left plate 22, and the right plate 23 can be separated from each other two by two to form a triangular standing configuration for supporting the mounting plate 1;

through the triangular standing configuration, the mounting plate 1 and the electronic product 4 can be raised to a certain height relative to the tabletop or the group, which effectively improves the comfort of user when using the electronic product 4, avoids neck pain and discomfort caused by excessive lowering of the neck and head, and also effectively separates the electronic product 4 from a stained or wet tabletop;

correspondingly, when the holder needs to be stowed, the left plate 22 and the right plate 23 can be rotated respectively to restore the main plate 21, the left plate 22, and the right plate 23 to a same plane, to form an integrated structure of the support plate 2, and the support plate 2 is then rotated into the stowing area 14 of the mounting plate 1 for storage; and

further, each of the main plate 21, the left plate 22, and the right plate 23 is provided with an anti-slip sleeve 24 at one end away from the mounting plate 1, to enhance the stability of the triangular standing configuration.

It is worth noting that, in some embodiments, the mounting plate 1 and the support plate 2 may be rotatably connected via a rotating shaft, and the main plate 21, the left plate 22, and the right plate 23 may also be rotatably connected via rotating shafts. Alternatively, ball joint connections may be used between the mounting plate 1 and the support plate 2, as well as among the main plate 21, the left plate 22, and the right plate 23; or a combination of rotating shafts and ball joints may be used for a plurality of rotatable connections.

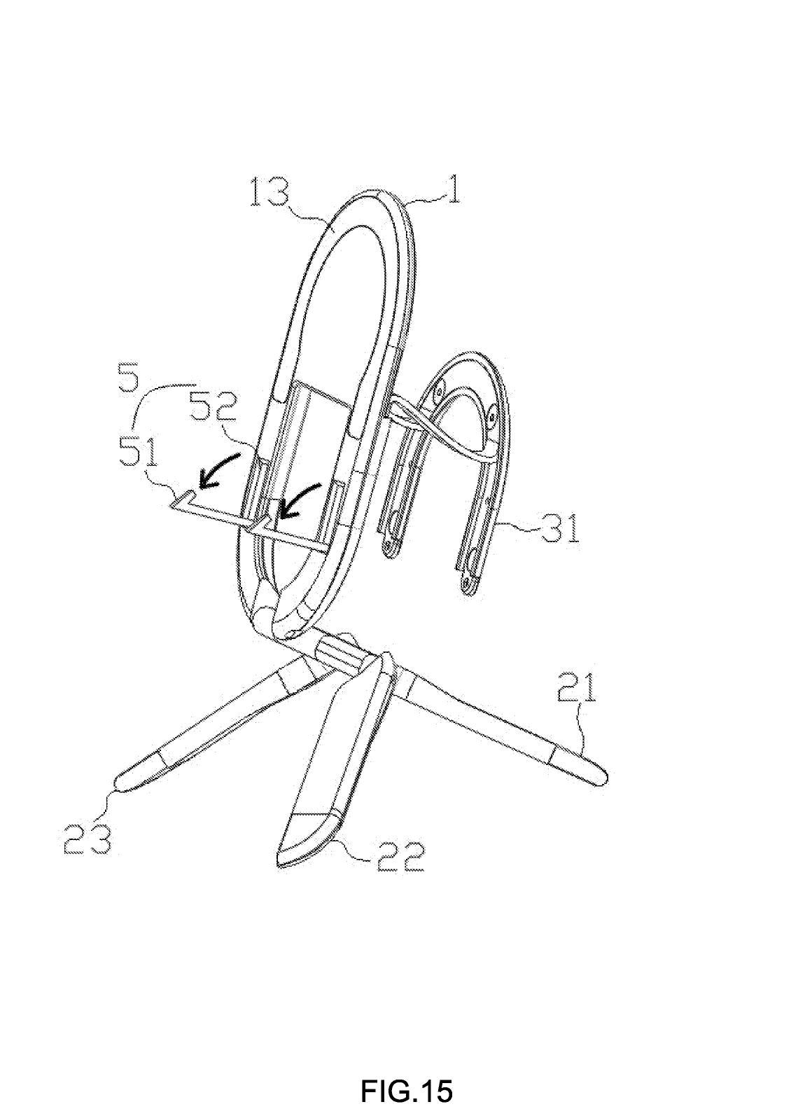

Preferably, as shown in FIG. 15, two latching mechanisms 5 may be symmetrically arranged on an end face of the mounting plate 1 facing the electronic product 4 and located below the first magnetic member 13; and each of the latching mechanisms 5 includes a latch hook 51 arranged on the mounting plate 1 and rotatably connected to the mounting plate 1, and a latch slot 52 for receiving the latch hook 51. When the holder is used to support a heavy electronic product 4 (such as a tablet) with a large size, the first magnetic member 13 cannot provide sufficient magnetic force to effectively secure the tablet, in this case, the tablet needs to be placed on the latch hook 51, so as to achieve effective fixation and support of the tablet. In addition, when the latch hook 51 is not in use, the latch hook 51 may be rotated and stowed in the latch slots 52.

Working principle of the present disclosure will be described in detail below:
when being mounted, the first connecting portion 321 of the connecting member 32 is first fitted into the receiving slot 313 of the cover plate 31, such that the first protrusion portion 323 fits snugly into the first recess 311, the first pressing plate 33 fits snugly into the first recessed portion 324, and the cover plate 31 is fixedly connected to the first pressing plate 33 via the screws 312, thereby fixing the first connecting portion 321;
then, the second protrusion portion 326 on the second connecting portion 322 of the connecting member 32 is fitted into the second recess 11 of the mounting plate 1, the second pressing plate 34 is then fitted into the second recessed portion 327, and fixedly connected to the second pressing plate 34 and the mounting plate 1 via the screws 312, thereby fixing the second connecting portion 322;
when it is necessary to hold the support assembly or the electronic product 4 by hand, the user may simply pull the cover plate 31 out from the placement recess 12 of the mounting plate 1, such that the cover plate 31, the mounting plate 1, and the connecting member 32 together form an "H"-shaped structure, and the user inserts his/her fingers into a space between the cover plate 31 and the mounting plate 1 to grip the connecting member 32; and
when the electronic product 4 needs to be supported, the user only need to push the support plate 2 out from the stowing area 14 of the mounting plate 1 and adjust the mounting plate 1 and the support plate 2 to a suitable support angle, so as to realize the support and fixation of the electronic product 4; in addition, the left plate 22 and the right plate 23 can be rotated, such that the main plate 21, the left plate 22, and the right plate 23 can be separated from each other two by two to form a triangular standing configuration for support and fixation.

The innovative aspect of the present disclosure lies in the arrangement of a handheld assembly capable of freely switching between a stowed state and an open state, the problems of unstable handheld use and low safety of electronic products are solved. In addition, the first protrusion portion and the second protrusion portion of the connecting member fit snugly into the first recess on the cover plate and the second recess on the mounting plate, respectively, and the first pressing plate and the second pressing plate adopt compressive engagement, which increase the contact areas between the connecting member and the cover plate, and between the connecting member and the mounting plate, and enhances the stability of connection between the connecting member and the cover plate and the mounting plate, thereby resulting in a more stable and secure connection.

In addition, it should be understood that although the description is described according to implementations, each implementation does not include only one independent technical solution, the description is for clarity only, and those skilled in the art should take the description as a whole, the technical solutions in the various embodiments may be appropriately combined to form other implementations understandable by those skilled in the art.

For those skilled in the art, it is apparent that the present disclosure is not limited to details of the exemplary embodiments, and the present disclosure can be implemented in other specific forms without departing from the spirit or basic features of the present disclosure. Therefore, the embodiments should be regarded as illustrative and non-restrictive no matter from which point of view. The scope of the present disclosure is defined by the appended claims rather than the above specification, and therefore, it is intended that all changes which fall within the meaning and scope of equivalency of the claims are embraced in the present disclosure. Any reference numerals in the claims should not be construed as limiting the claims to which they relate.

What is claimed is:

1. A portable holder, comprising a mounting plate and a support plate for supporting the mounting plate, wherein the mounting plate is rotatably connected to the support plate, a handheld assembly is arranged on the mounting plate; wherein the handheld assembly comprises a cover plate and a connecting member, one end of the connecting member is provided with a first connecting portion connected to the cover plate, and the other end of the connecting member is provided with a second connecting portion connected to the mounting plate;
when the handheld assembly is in an open state, the mounting plate and the cover plate are separated from each other, and the connecting member extends transversely between the mounting plate and the cover plate;
when the handheld assembly is in a stowed state, the connecting member is vertically sandwiched between the mounting plate and the cover plate, and the three members are tightly pressed together for convenient storage; and
a first protrusion portion is formed on one end face of the first connecting portion, a first recess is formed on the cover plate, the first protrusion portion fits snugly into the first recess, a first recessed portion corresponding to the first protrusion portion is formed on the other end face of the first connecting portion, a first pressing plate is arranged in the first recessed portion, and the first pressing plate and the cover plate are configured to clamp and secure the first connecting portion.

2. The portable holder according to claim 1, wherein the first pressing plate is secured to the cover plate via a riveted connection or screws.

3. The portable holder according to claim 2, wherein a protruding ring is arranged in the first recessed portion, and a recessed ring in fitted connection with the protruding ring is arranged on the first pressing plate.

4. The portable holder according to claim 1, wherein a second protrusion portion is formed on one end face of the second connecting portion, a second recess in fitted connection with the second protrusion portion is formed on the mounting plate, a second recessed portion corresponding to the second protrusion portion is formed on the other end face of the second connecting portion, a second pressing plate is arranged in the second recessed portion, and the second pressing plate and the mounting plate are configured to clamp and secure the second connecting portion.

5. The portable holder according to claim 4, wherein the second pressing plate is secured to the mounting plate via a riveted connection or screws.

6. The portable holder according to claim 1, wherein the connecting member is provided with a crease groove.

7. The portable holder according to claim 1, wherein the cover plate is provided with a receiving slot that corresponds to the connecting member, and a depth of the receiving slot is dimensioned to match a thickness of the connecting member.

8. The portable holder according to claim 7, wherein the mounting plate is provided with a placement recess that corresponds to the cover plate, and a depth of the placement recess is dimensioned to match a thickness of the cover plate.

9. The portable holder according to claim 1, wherein the mounting plate is provided with a first magnetic member, the cover plate is provided with a second magnetic member magnetically attracted to the first magnetic element, the first magnetic member is a magnet, and the second magnetic member is a magnet or a magnetically conductive material.

10. The portable holder according to claim 1, wherein the support plate comprises a main plate, a left plate, and a right plate, one end of the support plate is rotatably connected to the mounting plate, the left plate and the right plate are rotatably connected to two sides of the main plate, respectively, and the main plate, the left plate, and the right plate is separated from each other two by two to form a triangular standing configuration for supporting the mounting plate.
